(19) United States
(12) Patent Application Publication
(10) Pub. No.: US 2009/0165063 A1
(43) Pub. Date: Jun. 25, 2009

(54) Method for centrally distributing screensaver video to protect display devices

(75) Inventors: Su-Woan Chow, Taipei (TW); Ching-San Hsu, Taipei (TW); Chie-Jin Cheng, Taipei (TW); Pong-Sheng Wang, Taipei (TW); Chiung-Yueh Chang, Taipei (TW); Quxiang Fang, Sunnyvale, CA (US)

Correspondence Address: BACON & THOMAS, PLLC, 625 SLATERS LANE, FOURTH FLOOR, ALEXANDRIA, VA, 22314-1176, US

(73) Assignee: NSTREAMS TECHNOLOGIES, INC., Taipei (TW)

(21) Appl. No.: 12/000,950

(22) Filed: Dec. 19, 2007

(51) Int. Cl. H04N 7/173

(52) U.S. Cl. 725/87

(57) ABSTRACT

The present invention is to provide a method for centrally distributing screensaver video to protect display devices, which is implemented to a central VOD system comprising a remote video server, a plurality of signal transmission devices, and display devices each connected to a signal transmission device. The remote video server has a plurality of ordinary video data and at least a screensaver video data therein; each signal transmission device may receive a screensaver video data and at least one ordinary video data, and then transmit the screensaver video data and the ordinary video data to the display device connected thereto. The signal transmission device outputs the screensaver data on the display device when not receiving any control signal within a predetermined period of time, and does not resume the original ordinary video data on the display device unless the signal transmission device receives the control signal again.

### FIELD OF THE INVENTION

The invention relates to a method for centrally distributing screensaver video to protect display devices, and more particularly to a method for displaying a screensaver video stored in a remote video server on a plurality of display devices connected to the remote video server when not receiving any control signal within a predetermined period of time, so as to prevent ghost like images from forming on the screens of the display devices due to displaying an identical image for a long time, maintain the picture quality and prolong the lifespan of the display devices.

### BACKGROUND OF THE INVENTION

With the arrival of a technologically advanced age in which the electronic industries thrives, a variety of electronic multimedia products are constantly renewed, which in turn offers consumers more choice in their demand for entertainment-related products. Moreover, with the continuous advancement in various electronic technologies, the monitors and display devices of all related electronic products also keep improving. Consequently, the standard of all such display devices is raised in order to meet the demands of consumers, increase profitability, and reduce the cost of such products.

For a conventional display device (including flat screen TV, flat panel, or CRT), a user usually spends at least 8-12 hours on using the product. After a long period of usage, especially if the device is used to show an identical image for a long time; the burn-in effect is easily induced and left on the screen of the device due to the fact that the same positions of the screen are constantly impacted by negative ions. Subsequently, when the device is turned off or switched to another frame, a ghost like image of the previous frame is left on the screen, and the ghost like image may even become permanent, which not only reduces the lifespan of the display device, but also lowers the picture quality of such device.

To solve the aforesaid problem, makers of the display device install a screensaver program therein, and allow users to configure the display device such that a predetermined screensaver video (such as moving product names or moving company logos) may be shown on the screen of the display device after showing an identical image for a long time, or make the display device enter a hibernation mode, or turn off the display device, so that the screen of the device is protected from the burn-in effect. However, in places like hotels, hospitals, or schools; where there might be hundred of display devices under the control of a central system, and the display devices could be of different specifications (such as traditional CRT TV or plasma TV) or brands (i.e. have different methods of configuration). If it becomes necessary to configure the screensaver programs of all display devices, or reset the screensaver programs after any accidental misconfigurations, then the maintenance staffs need to be sent in order to re-configure and maintain the screensaver programs of all display devices. As a result, the cost for maintaining the screensaver programs of all display devices would increase steadily and become a burden. Therefore, a method for centrally distributing a screensaver video to protect display devices that solves the aforesaid problems is urgently needed.

### SUMMARY OF THE INVENTION

In light of the aforesaid problems, a method for centrally distributing a screensaver video to protect display devices has been disclosed in the invention. The method is implemented to a central VOD (Video On Demand) system that is usually installed in hotels, hospitals, or schools; the central VOD system comprises a remote video server, a plurality of signal transmission devices, and display devices each connected to a single signal transmission device. The remote video server has a plurality of video programs and at least a screensaver program for displaying the screensaver video therein; each signal transmission device may receive a screensaver video data and at least one ordinary video data respectively, and then transmit the screensaver video data and the ordinary video data to the display devices connected thereto. If the signal transmission device doesn't receive the ordinary video data and any control signal for controlling the ordinary video data within a predetermined period of time, the signal transmission device outputs the screensaver video data on the display device, and does not resume the original ordinary video data on the display device unless the signal transmission device receives the control signal again.

A primary objective of the invention is to prevent ghost like images from forming on the screens of the display devices due to displaying an identical image for a long time, so as to maintain the picture quality and prolong the lifespan of the display devices.

Another objective of the invention is to centrally distribute screensaver video to each of the display devices without having to take the specifications and other related restrictions of the display devices into consideration, so that less maintenance staffs for the display devices are required, and thus the labor cost and the maintenance cost of the display devices may be reduced.

A further objective of the invention is to centrally distribute any messages (such as advertisements or public notifications) to the display devices.

### BRIEF DESCRIPTION OF DRAWINGS

The technical means adopted by the present invention to achieve the above and other objectives can be best understood by referring to the following detailed description of the preferred embodiments and the accompanying diagrams, wherein:

FIG. 1 is a schematic view that shows the invention;

FIG. 2 is a flow chart that shows a preferred embodiment according to the invention; and

FIG. 3 is a schematic view that shows a broadcast timetable according to the invention.

### DETAILED DESCRIPTION OF PREFERRED EMBODIMENTS

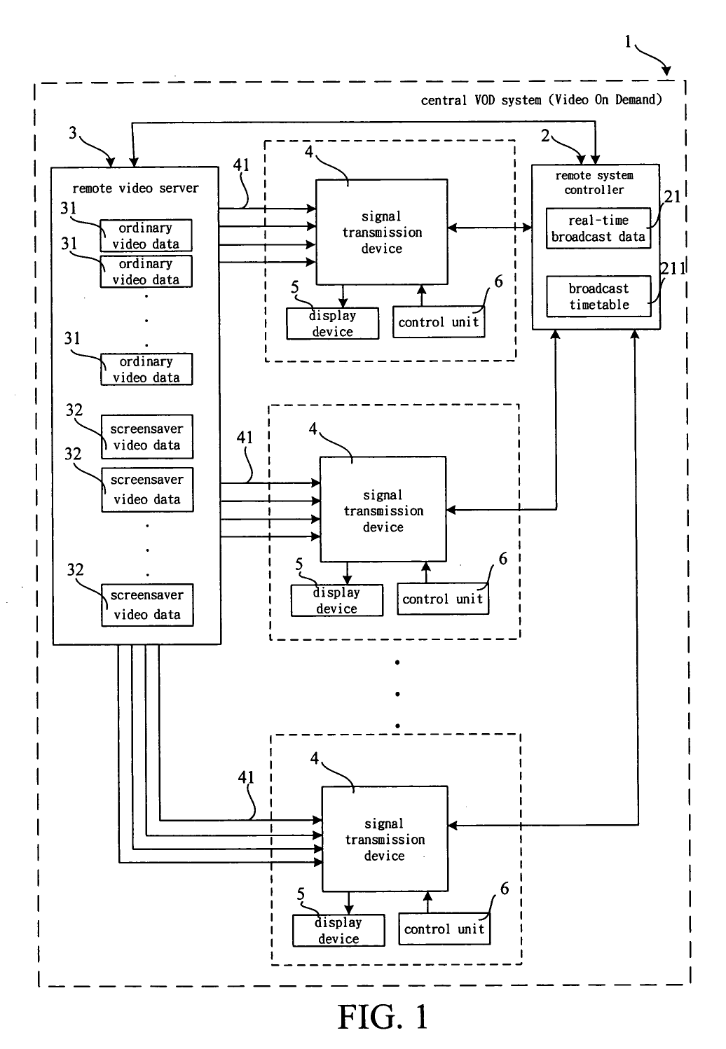

As shown in FIG. 1, a method for centrally distributing screensaver video to protect display devices has been disclosed in the invention; the method is implemented to a central VOD (Video On Demand) system 1, and the central VOD system 1 comprises a remote system controller 2, at least a remote video server 3, a plurality of signal transmission devices 4 (such as setup boxes or In-Room Communicator), as well as a display device 5 that is connected to each of the signal transmission devices 4. The remote video server 3 has a plurality of ordinary video data 31 and at least one screensaver video data 32 therein; the remote video server 3 is connected to each of the signal transmission devices 4 via a plurality of channels 41. The remote system controller 2 is connected to the remote video server 3 and also to each of the signal transmission devices 4, so that the remote video server 3 may continuously transmit the screensaver video data 32 via one of the channels 41. Accordingly, the remote video server 3 may transmit an ordinary video data 31 corresponding to a demand from one of the signal transmission devices 4 via the channels 41.

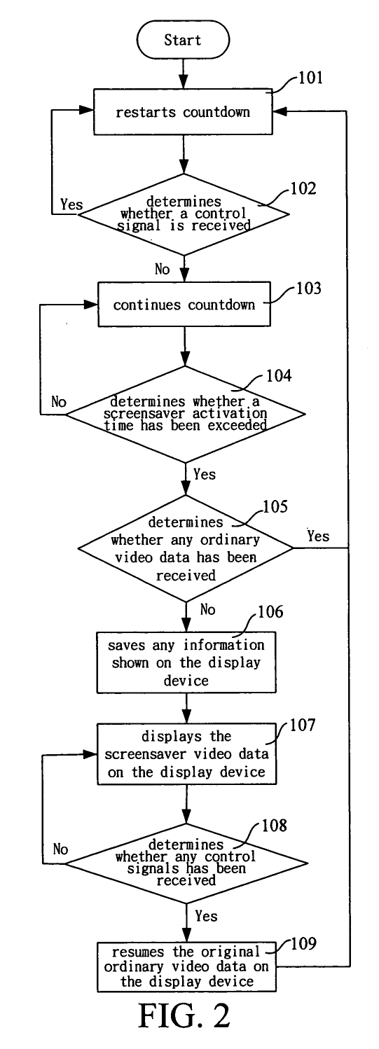

After the central VOD system 1 is activated, the remote system controller 2 transmits a transmission data (for instance, a channel number of the screensaver video data 32 and a channel frequency of such channel number, or a data number and service number of the remote video server 3) of each screensaver video data 32 to the signal transmission device 4, so that the signal transmission device 4 receives a channel number and a channel frequency of the screensaver video data 32, which are required for obtaining the screensaver video data 32. Therefore, when the signal transmission device 4 receives a control signal transmitted from a control unit 6 (such as a remote control or a keyboard), the signal transmission device 4 sends out a request to the remote system controller 2 for transmitting an ordinary video data 31 via one of the channels 41. Subsequently, the remote system controller 2 allows the remote video server 3 to transmit a corresponding ordinary video data 31 to the display device 5 via one of the channels 41 according to the control signal from the control unit 6, the screensaver video data 32 is also constantly transmitted to each signal transmission device 4 via one of the channels 41 and is waiting to be switched by the signal transmission device 4 for transmitting to the corresponding display device 5. Referring to FIG. 2; once the signal transmission device 4 switches mode, the signal transmission device 4 carries out the method for centrally distributing the screensaver video data 32 to protect display devices according to the following steps:
(101) allowing a time meter of the signal transmission device 4 to start countdown;
(102) determining whether any control signals transmitted from the control unit 6 has been received or not; if yes, going to the step (101), otherwise, going to the step (103) instead;
(103) allowing the time meter to continue the countdown;
(104) determining whether a screensaver video activation time (for instance, a period of 30 seconds or 150 seconds) preconfigured in the signal transmission device 4 has been exceeded according to the time meter; if yes, going to the step (105), otherwise, going to the step (103) instead;
(105) determining whether any ordinary video data transmitted from the remote video server 3 has been received or not; if yes, going to the step (101), otherwise, going to the step (106) instead;
(106) saving any information (for example, a channel 41 of a selection menu) shown on the display device 5 to a buffer;
(107) switching to a channel 41 taken up by the screensaver video data 32 according to a channel number and a channel frequency of the screensaver video data 32, and then outputting the screensaver video data 32 to the display device 5;
(108) determining whether any control signals transmitted from the control unit 6 has been received or not; if yes, going to the step (109), otherwise, going to the step (107) instead;
(109) switching back to the original channel 41 to resume the original ordinary video data 31 according to the information about the original channel 41 saved in the buffer, and return to the step (101).

Therefore, the screensaver video data 32 shown on the display device 5 is constantly moving on the screen of the display device 5, thus the display device 5 may be protected from having a ghost like image left on the screen due to displaying an identical image for a long period of time, which consequently prolongs the lifespan of the display device 5.

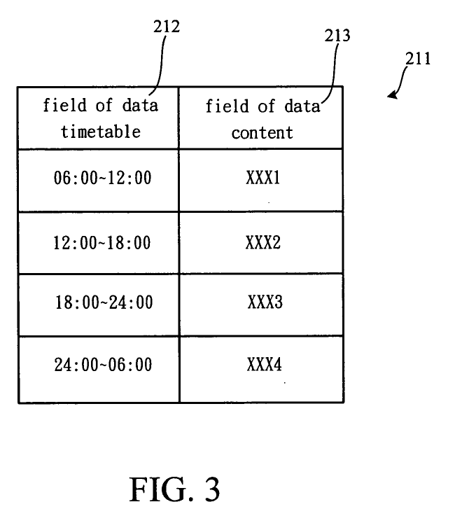

Referring to FIGS. 1 and 3, the remote system controller 2 or the remote video server 3 has a real-time broadcast data 21 and a broadcast timetable 211 saved therein. The broadcast timetable 211 contains a field of data timetable 212 and a field of data content 213; the start/end time of and intervals between data are recorded in the field of data timetable 212 (for example, 06:00-12:00, 12:00-18:00), and serial numbers for each of the screensaver video data 32 are recorded in the field of data content 213. The real-time broadcast data 21 decides when to display the screensaver video data 32 on the basis of the intervals between the ordinary video data and corresponding screensaver video data 32 thereof recorded in the broadcast timetable 211.

It should be noted that even though the conditions for switching on the screensaver video data 32 in this invention is similar to that for the traditional screensaver video, the invention allows the remote video server 3 to continuously transmit the ordinary video data to the signal transmission device 4, and does not switch on and display the screensaver video data 32 on the display device 5 unless the conditions for switching on the screensaver video data 32 are met. As a result, it is unnecessary for makers of the display device 5 to install, configure, or modify screensaver program for every single display device 5.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method for centrally distributing screensaver video to protect display devices being applied to a central VOD system, the central VOD system comprises a remote video server, a plurality of signal transmission devices, and a display device being connected to each of the signal transmission devices, wherein the remote video server is connected to each of the signal transmission devices via a plurality of channels; the method comprising:
continuously transmitting at least one screensaver video data to each of the signal transmission devices by the means of the remote video server via one of the channels;
determining whether each of the signal transmission devices has received any ordinary video data or control signal for controlling the ordinary video data via one of the channels within a predetermined time;
after determining one of the signal transmission devices has not received any ordinary video data or control signal within the predetermined time, the signal transmission device that has not received any ordinary video data or control signal outputs the screensaver video data to the display device.

2. The method of claim 1, wherein the signal transmission device determines whether any ordinary video data or control signal has been received within a predetermined time according to the steps below:
determining whether any control signal has been received or not;
when the signal transmission device has not received the control signal, subsequently determining whether a screensaver activation time preconfigured in the signal transmission device has been exceeded or not;
determining whether any ordinary video data transmitted from the remote video server has been received or not;
when the signal transmission device has not received any ordinary video data transmitted from the remote video server, subsequently saving any information shown on the display device and outputting the screensaver video data to the display device.

3. The method of claim 2, wherein the signal transmission device switches to a channel corresponding to the screensaver video data according to a channel number and a channel frequency of the screensaver video data, and then displays the screensaver video data on the display device.

4. The method of claim 3, wherein when the signal transmission device again determines a control signal has been received, and the signal transmission device resumes displaying an original ordinary video data shown on the display device prior to the display of the screensaver video data.

5. The method of claim 3, wherein a real-time broadcast data of the central VOD system transmits a screensaver video data to the signal transmission device; the screensaver video data corresponds to a plurality of intervals recorded on a broadcast timetable.
